(19) United States
(12) Patent Application Publication
(10) Pub. No.: US 2025/0037018 A1
(43) Pub. Date: Jan. 30, 2025

(54) MEMORY-EFFICIENT DIFFERENTIABLE WEIGHT CLUSTERING FOR LARGE LANGUAGE MODEL COMPRESSION

(71) Applicant: Apple Inc., Cupertino, CA (US)

(72) Inventors: Minsik CHO, Austin, TX (US); Keivan ALIZADEH VAHID, Seattle, WA (US); Qichen FU, Bellevue, WA (US); Saurabh ADYA, San Jose, CA (US); Carlo Eduardo Cabanero DEL MUNDO, Bellevue, WA (US); Mohammad RASTEGARI, Kirkland, WA (US); Devang K. NAIK, San Jose, CA (US); Peter ZATLOUKAL, Seattle, WA (US)

(21) Appl. No.: 18/658,919

(22) Filed: May 8, 2024

Related U.S. Application Data
(60) Provisional application No. 63/529,665, filed on Jul. 28, 2023.

(51) Int. Cl. G06N 20/00

(52) U.S. Cl. CPC G06N 20/00

(57) ABSTRACT

The subject technology provides memory-efficient differentiable weight clustering for large language model compression. An apparatus determines a tensor including an attention map between learned weights of a trained machine learning model and corresponding centroids. The apparatus also determines a compressed attention table and a plurality of index lists during compression of the trained machine learning model based on an uniquification of the attention map and sharding of an associated index list. The apparatus determines whether the tensor exists at a destination device during compression of the trained machine learning model using a marshaling layer. The apparatus refrains from copying the tensor to the destination device when the tensor exists at the destination device, or copies the tensor to the destination device when the tensor does not exist at the destination device. The apparatus deploys a compressed machine learning model based on the compression of the trained machine learning model.

### CROSS-REFERENCE TO RELATED APPLICATION(S)

This application claims the benefit of U.S. Provisional Application Ser. No. 63/529,665, entitled “MEMORY-EFFICIENT DIFFERENTIABLE WEIGHT CLUSTERING FOR LARGE LANGUAGE MODEL COMPRESSION,” and filed on Jul. 28, 2023, the disclosure of which is expressly incorporated by reference herein in its entirety.

### TECHNICAL FIELD

The present description generally relates to memory-efficient differentiable weight clustering for large language model compression.

### BACKGROUND

Large language models are characterized by their substantial size, often comprising hundreds of millions to billions of parameters. These models require significant computational power and memory for training and inference. The vast number of parameters allows them to capture complex linguistic patterns and generate coherent and contextually relevant text, making them powerful tools in natural language processing tasks. However, their size also presents challenges related to resource consumption and deployment on constrained platforms.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example computing architecture for a system providing machine learning models, in accordance with one or more implementations.

FIG. 3 conceptually illustrates an example overview of a weight optimization system in accordance with one or more implementations.

FIG. 4A is a schematic diagram illustrating an example of a weight optimization system without applying cross-device tensor marshaling in accordance with one or more implementations.

FIG. 4B is a schematic diagram illustrating an example of a weight optimization system applying cross-device tensor marshaling in accordance with one or more implementations.

FIG. 5 is a schematic diagram illustrating an example of a weight optimization system applying weight uniquification and sharding in accordance with one or more implementations.

FIG. 6 is a flow chart of an example process that may be performed for memory-efficient differentiable weight clustering for large language model compression in accordance with one or more implementations.

FIG. 7 is a flow chart of another example process that may be performed for memory-efficient differentiable weight clustering for large language model compression in accordance with one or more implementations.

FIG. 8 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Machine learning has seen a significant rise in popularity in recent years due to the availability of training data, and advances in more powerful and efficient computing hardware. Machine learning may utilize models that are executed to provide predictions in particular applications.

Large language models (LLMs), including Generative Pre-trained Transformer (GPT) models have shown an increase in performance on complex language tasks. As a result, there is a growing interest in deploying these models on-device to ensure user privacy. However, even the smallest state-of-the-art LLMs are too large for on-device execution. For example, the smallest Lightweight and Low-power Machine Learning Accelerator (Llama) model (a highly compressed LLM), with over 7 billion parameters, requires a substantial amount of memory (e.g., 14 GB), while high-end mobile devices can only offer up to 8 GB dynamic random access memory (DRAM).

Aggressively compressing LLMs via training-time (or “train-time”) optimizations, such as sparsification, quantization, or weight-clustering, may be useful for on-device LLM deployment. However, this process is highly expensive due to the sheer model size and computational resource overhead. As a result, many existing LLM compression techniques rely on post-training optimization.

Due to the high-quality performance demonstrated by LLMs in various complex language tasks, there is significant interest in deploying these LLMs on mobile devices for faster responses and improved privacy protection. However, the substantial size of LLMs, with billions of parameters, necessitates highly effective compression techniques to accommodate storage-limited devices. Among the compression approaches, weight-clustering, a type of non-linear quantization, stands as a prominent candidate for LLM compression. Nevertheless, the training overhead for LLM fine-tuning, especially with Differentiable KMeans Clustering (DKM), presents a considerable challenge. Although DKM offers a state-of-the-art trade-off between compression ratio and accuracy regression, its substantial memory complexity makes it nearly impractical for train-time LLM compression.

In the present disclosure, the technique of applying weight clustering to compress LLMs is applied, considering its potential to achieve a state-of-the-art trade-off between model accuracy and size. Specifically, embodiments of the subject technology concentrate on memory optimization techniques to enable DKM for LLama compression, which is known for its substantial memory complexity. In this regard, the subject technology provides for a memory-efficient DKM (eDKM) implementation empowered by novel techniques that reduce the memory footprint of DKM by orders of magnitudes. For a given tensor intended for saving on the CPU during the backward pass of DKM, the subject technology can compress the tensor by applying uniquification and sharding, after verifying the absence of any duplicated tensors previously copied to the CPU. In one or more implementations, embodiments of the subject technology involving eDKM can compress an LLM into 3 bits per weight while achieving state-of-the-art accuracy on a broader range of LLM benchmarks.

Implementations of the subject technology improve the ability of a given electronic device to provide machine-learning generated data to a user (e.g., a user of the given electronic device). These benefits therefore are understood as improving the computing functionality of a given electronic device, such as an end user device which may generally have less computational and/or power resources available than, e.g., one or more cloud-based servers.

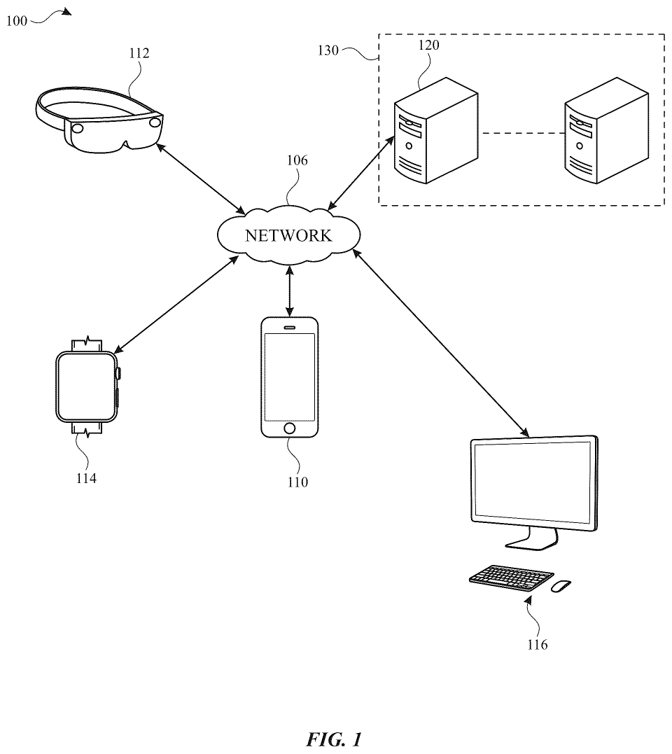

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, and the server 120; however, the network environment 100 may include any number of electronic devices and any number of servers or a data center including multiple servers.

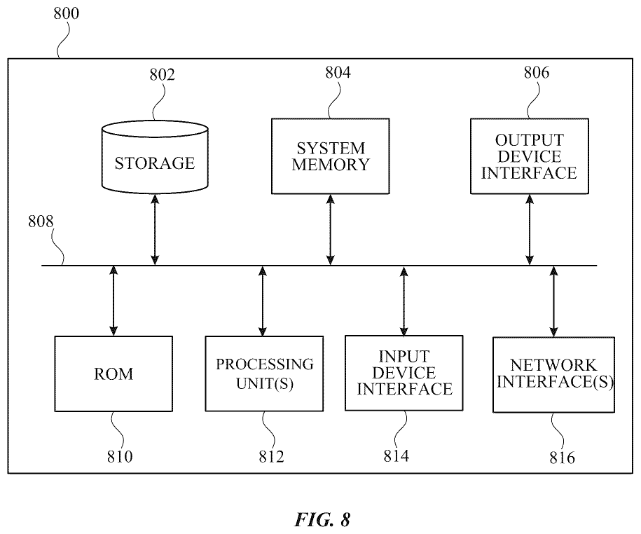

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 8.

The electronic device 112 may be, for example, desktop computer, a portable computing device such as a laptop computer, a smartphone, a peripheral device (e.g., a digital camera, headphones), a tablet device, or a wearable device such as a head mountable portable system, that includes a display system capable of presenting a visualization of an extended reality environment to a user. In FIG. 1, by way of example, the electronic device 112 is depicted as a head mountable portable system. The electronic device 112 may be, and/or may include all or part of, the electronic system discussed below with respect to FIG. 8.

The electronic device 114 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 114 is depicted as a watch. The electronic device 114 may be, and/or may include all or part of, the electronic system discussed below with respect to FIG. 8.

The electronic device 116 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 116 is depicted as a desktop computer. The electronic device 116 may be, and/or may include all or part of, the electronic system discussed below with respect to FIG. 8.

In one or more implementations, one or more of the electronic devices 110-116 may provide a system for training a machine learning model using training data, where the trained machine learning model is subsequently deployed to one or more of the electronic devices 110-116. Further, one or more of the electronic devices 110-116 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-116 may be performed entirely on the electronic devices 110-116, to prevent exposure of individually identifiable data to devices and/or systems that are not authorized by the user.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

The server 120 may provide a system for training a machine learning model using training data, where the trained machine learning model is subsequently deployed to the server 120 and/or to one or more of the electronic devices 110-116. In an implementation, the server 120 may train a given machine learning model for deployment to a client electronic device (e.g., the electronic device 110, the electronic device 112, the electronic device 114, the electronic device 116). In one or more implementations, the server 120 may train portions of the machine learning model using (e.g., anonymized) training data from a population of users, and one or more of the electronic devices 110-116 may train portions of the machine learning model using individual training data from the user of the electronic devices 110-116. The machine learning model deployed on the server 120 and/or one or more of the electronic devices 110-116 can then perform one or more machine learning algorithms. In an implementation, the server 120 provides a cloud service that utilizes the trained machine learning model and/or continually learns over time.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

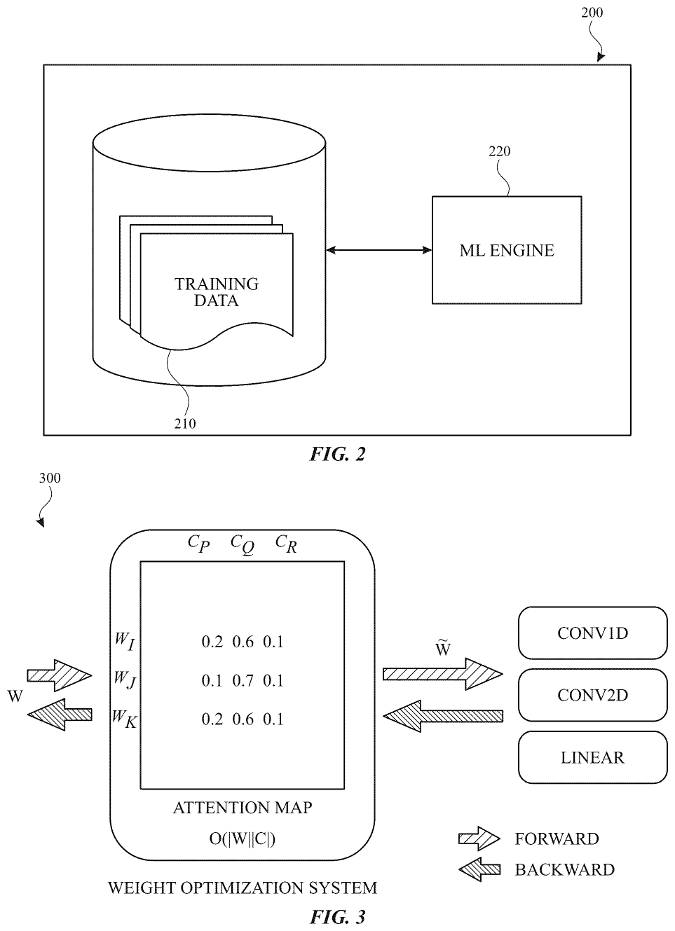

FIG. 2 illustrates an example computing architecture for a system providing machine learning models, in accordance with one or more implementations. For explanatory purposes, the computing architecture is described as being provided by an electronic device 200, such as by a processor and/or memory of the server 120, or by a processor and/or a memory of any other electronic device, such as the electronic device 110. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 200 includes training data 210 for training a machine learning model. In an example, the server 120 may utilize one or more machine learning algorithms that uses training data 210 for training a machine learning (ML) model 220. Machine learning model 220 may include one or more neural networks.

At train-time, optimizing an LLM incurs significant expenses attributable to the model size and computational resource overhead. Notably, the computational resource demand for a differentiable weight clustering process during training in DKM, an advanced weight clustering algorithm, is excessively high. This demand arises from the need to analyze interactions among all weights and potential clustering options. Consequently, many current LLM compression methods resort to post-training optimization. In one or more implementations, the electronic device 200 (by way of the training data 210) can facilitate train-time weight clustering and apply them to DKM, resulting in eDKM. The compression techniques applied to the ML model 200 can encompass cross-device tensor marshaling and weight matrix uniquification and/or sharding. Using eDKM to fine-tune and compress the ML model 220 to a reduced number of bits per weight can result in a significant reduction in memory footprint for a decoder stack, surpassing existing multi-bit compression techniques in performance.

FIG. 3 conceptually illustrates an example overview of a weight optimization system 300 in accordance with one or more implementations. A general overview of the weight optimization system 300 is provided, and within the weight optimization systems 300, an attention map for differentiable weight clustering is created.

Popular weight optimization techniques such as pruning, quantization, and normalization are employed to transform the original weights, W, into optimized weights, W, aiming to enhance inference latency, training accuracy, or model size, as illustrated in FIG. 3. In the present disclosure, embodiments of the subject technology center on weight clustering, specifically the state-of-the-art weight clustering algorithm, DKM. Weight clustering involves non-linear weight discretization, and DKM achieves a trade-off between model compression and accuracy by jointly optimizing the weight gradient and the cluster centroids with respect to the task loss. The interaction analysis between the weights (W) and centroids (C) necessitates a larger attention map with O(|W∥C|) memory complexity for both forward and backward passes, which poses a notable challenge for LLM compression. For instance, a LLaMA 7B model may facilitate at least 224 GB for 4-bit weight clustering in 16-bit precision.

In one or more implementations, two novel memory optimization techniques are introduced in a deep learning framework to address such challenges: (1) cross-device marshalling, and (2) weight uniquification and sharding. In cross-device marshalling, the tensors being copied across devices is tracked. In this regard, the tracking of tensors being copied across devices allows for the avoidance of redundant copying. This reduction in memory footprint and acceleration of training are achieved through the implemented technique. In weight uniquification and sharding, the leveraging of the fact that weights in 16 bits possess only 216 unique values is performed to reduce the representation of the attention map. Additionally, it is further sharded over multiple learners through the implemented technique.

In the deep learning framework, a tensor is represented with a data storage that links to the actual data layout, along with metadata that stores tensor shapes, types, and other relevant information. This tensor architecture enables the deep learning framework to optimize memory usage by reusing data storage whenever possible, thereby efficiently reducing the memory footprint and improving training speed. However, when a tensor is transferred to a different device (e.g., from GPU to CPU), the data storage cannot be reused, necessitating the creation of a completely new tensor (i.e., a copy of the tensor).

TABLE 1
Cross-Device Tensor Memory Utilization

| LINE | CODE | GPU | CPU |
|---|---|---|---|
| 0 | x0 = torch.rand([1024,1024]) | 4 | 0 |
| 1 | x1 = x0.view(−1,1) | 4 | 0 |
| 2 | y0 = x0.to(‘cpu’) | 4 | 4 |
| 3 | y1 = x1.to(‘cpu’) | 4 | 8 |

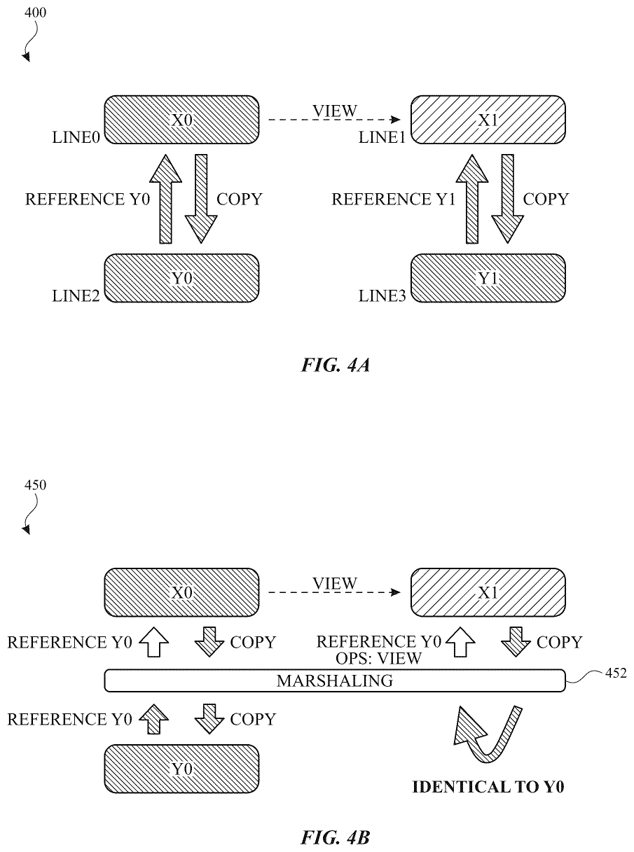

Table 1 illustrates the memory footprint overhead when a tensor moves to a different device in the deep learning framework. For instance, tensor x0 allocated in line 0 consumes 4 MB on the GPU. When its view is changed in line 1, no additional GPU memory is used since the underlying data storage can be reused. In one or more implementations, x1 corresponds to a particular view of x0, so while not necessarily identical, x1 includes all or part of x0. In one or more other implementations, x0 and x1 are effectively identical. However, when x0 and x1 are moved to the CPU, the CPU memory consumption increases to 8 MB, even though they share the same data storage on the CPU, resulting in redundancy on the CPU. Accordingly, the absence of cross-device tensor management can result in redundant copies across devices, particularly undesirable during LLM train-time optimization. For instance, even though x0 and x1 represent the same tensor with different views, when copied to the CPU, the resulting tensors y0 and y1 do not share the data storage, whereas x0 and x1 do on the GPU. FIG. 4A illustrates the example mentioned in Table 1, wherein x1 shares the data layout with x0, while y0 and y1 possess independent or duplicated data storage on the CPU. FIG. 4A is a schematic diagram illustrating an example of a weight optimization system 400 without applying cross-device tensor marshaling in accordance with one or more implementations.

To address such inefficiency, a marshaling layer 452 is introduced as depicted in FIG. 4B, where the black denotes actual data storage and metadata, while the gray represents only the metadata. FIG. 4B is a schematic diagram illustrating an example of a weight optimization system 450 applying cross-device tensor marshaling in accordance with one or more implementations. By incorporating the marshaling layer 452 as in FIG. 4B, redundancy is effectively avoided. Before copying a tensor to another device, a check is performed to ascertain the existence of identical data storage on the destination. If no such storage is found, the tensor is copied, and a ticket to the tensor is generated, containing its shape information. In one or more implementations, a ticket can refer to a pointer indicating a memory location storing a copy of data in response to a memory write request. For instance, since x1 and y0 share the same data storage, the original ticket generated for y0 is utilized instead of copying x1 to the CPU, as demonstrated in FIG. 4B.

When applying the proposed cross-device tensor marshaling to the scenario depicted in Table 1, duplication on the CPU side is effectively avoided, leading to memory and traffic savings. Before copying x1 to the CPU, the marshalling technique verifies the presence of a tensor with the same data storage on the CPU (i.e., y0). If such a tensor exists, the subject technology reuses the ticket associated with y0 for future retrieval.

The implementation of such a marshaling scheme involves utilizing the save tensor hook in the deep learning framework, which enables the determination of whether the same data storage has already been copied. However, performing a check to ascertain the existence of the same tensor on the destination device using conventional hashing methods proves to be prohibitively expensive. To address this, when a new tensor enters the marshaling system, the subject technology examines the forward graph to identify another tensor, already copied to the CPU, connected to the new tensor via a few hops, involving only data-storage invariant operations (e.g., view, transpose, etc.). If no such tensor is found, the subject technology proceeds with the copy request and generate the corresponding ticket. If found, the subject technology returns the reference of the existing tensor and the list of operations tracing back to the new tensor. For example, in FIG. 4B, instead of copying x1 to the CPU, the subject technology returns the reference to y0 and the view operation between x1 and y0. While navigating the computation graph incurs additional compute cycles, the saving from avoiding unnecessary copies compensates for this overhead. For example, searching within 4 hops may be sufficient to detect all qualified cases in the computation graph from the original DKM implementation.

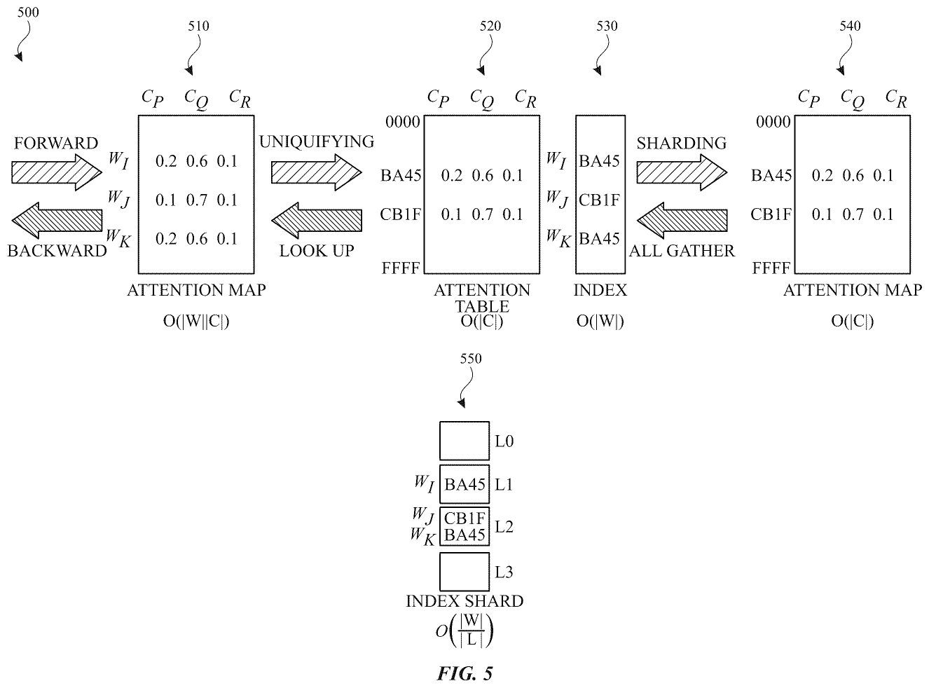

FIG. 5 is a schematic diagram illustrating an example of a weight optimization system 500 applying weight uniquification and sharding in accordance with one or more implementations. In most LLM training, the utilization of brainfloat 16 (BF16) is prevalent due to its extensive range. Consequently, despite the presence of multi-billion parameters in LLMs, the number of unique coefficients is limited to approximately 65,000 (2¹⁶) due to the bit-width constraint. This presents a valuable opportunity to achieve significant compression of an attention map 510 between weights and centroids, as depicted in FIG. 5. By calculating the attention to the centroids once for each unique weight, the attention map 510 can be transformed into an attention table 520 with O(|C|) complexity and an index list 530 with O(|W|) complexity. The attention table 520 contains at most about 65,536 rows, but in practice, only a few thousand rows may be utilized since the majority of weights lie within the range of (−1, 1).

While activations, in general, cannot be shared due to their data dependency, the index list 530 can be shared, as it is weight dependent and not data dependent in a fully synchronous training setup. Consequently, the index list 530 can be further sharded over a set of learners (denoted as C) during full synchronous training, resulting in a reduction of memory complexity to

$$O ( \frac{\vert W \vert}{\vert L \vert} ) .$$

However, the processes of uniquifying and sharding entail increased communication and computation costs, as the sharded weights necessitate all-gathering, and the attention table 520 and index list 530 can be converted back to the attention map 510 for backward propagation.

Assuming w_{{i,j,k}}∈W and c_{{p,q,r}}∈C, representing the weights and centroids, respectively, in FIG. 5, the scenario where w_{{i,k}} shares the same 16-bit representation CB1F, and wⱼ is represented by BA45 are considered. In such a case, wᵢ and wₖ can possess identical attention to C as in the full attention map 510 generated during the forward pass (also required for the backward pass). During the forward pass, following uniquification, the attention map 510 is deconstructed into a compressed attention table 540 with O(|C|) memory complexity and multiple index lists 550 with O([W]) complexity. Notably, the 16-bit value of the weight can directly reside in the index list 550. The index list 530 can be subsequently sharded over |L| learners (e.g., L0, L1, L2, L3) into the multiple index lists 550 to reduce the complexity in each learner

$$O ( \frac{\vert W \vert}{\vert L \vert} ) .$$

For the backward pass, the original attention map 510 may be reconstructed, necessitating reverse steps, such as all-gathering and look-up.

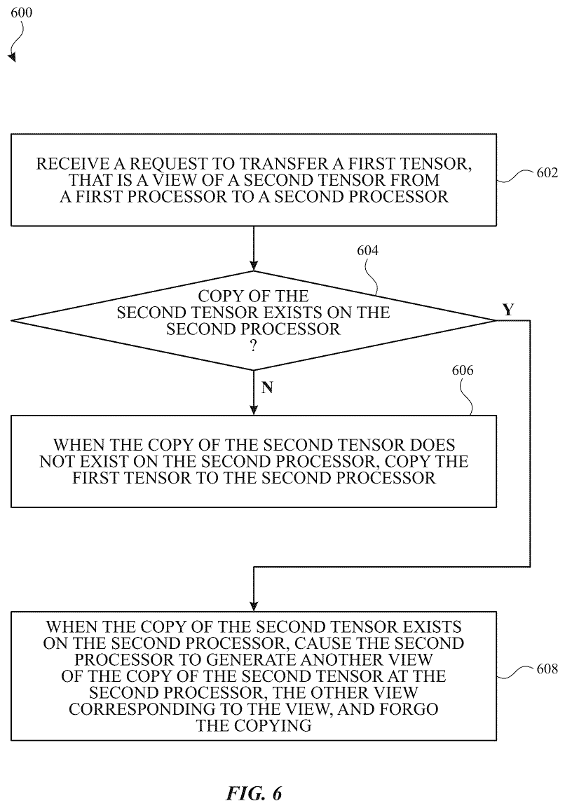

FIG. 6 is a flow chart of an example process that may be performed for memory-efficient differentiable weight clustering for large language model compression in accordance with one or more implementations. For explanatory purposes, the process 600 is primarily described herein with reference to the electronic device 110 of FIG. 1. However, the process 600 is not limited to the electronic device 110 of FIG. 1, and one or more blocks (or operations) of the process 600 may be performed by one or more other components of other suitable devices and/or servers. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, an apparatus (e.g., electronic device 110, 112, 114, 116; ML model 220; processing unit(s) 812) receives a request to transfer a first tensor, that is a view of a second tensor from a first processor to a second processor.

At block 604, the apparatus determines whether a copy of the second tensor exists on the second processor. If the copy of the second tensor does not exist on the second processor, then the process 600 proceeds to block 606. Otherwise, the process 600 proceeds to block 608.

At block 606, when the copy of the second tensor does not exist on the second processor, the apparatus copies the first tensor to the second processor. In copying the first tensor to the second processor, the apparatus may generate a reference associated with the first tensor. In some aspects, the reference refers to a pointer indicating a memory location storing a copy of data in response to a memory write request.

At block 608, when the copy of the second tensor exists on the second processor, the apparatus causes the second processor to generate another view of the copy of the second tensor at the second processor, the other view corresponding to the view, and forgo the copying. In causing the second processor to generate the other view of the copy of the second tensor, the apparatus can cause the second processor to reuse a reference associated with the second tensor. In one or more other implementations, the apparatus may cause the second processor to reuse one or more data storage invariant operations between the first tensor and the second tensor.

In one or more implementations, the operations recited in blocks 602-608 are part of applying compression to a trained machine learning model (e.g., ML model 220). In one or more implementations, the compressed machine learning model is deployed based at least in part on the compression applied to the trained machine learning model. In one or more other implementations, the machine learning model can be compressed and/or deployed after initializing the trained machine learning model. In one or more implementations, initializing a trained machine learning model refers to the process of setting its parameters or weights to specific values before applying any further modifications or operations such as compression. This initialization step can define the starting point from which subsequent operations will be performed. When a machine learning model is trained, its parameters are adjusted iteratively to minimize a predefined loss function and improve its performance on a given task. However, after training, these parameters may not be in an optimal state for deployment due to factors such as initialization choices, optimization algorithms, and convergence criteria during training. Therefore, initializing the trained model involves resetting its parameters or applying specific initialization techniques to prepare it for further processing, such as compression. This initialization step facilitates that the machine learning model is in a suitable state for compression without compromising its performance or generalization capabilities.

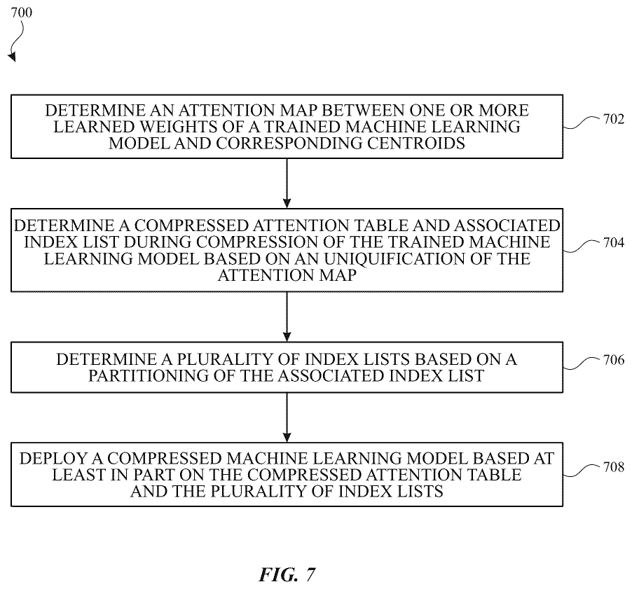

FIG. 7 is a flow chart of another example process that may be performed for memory-efficient differentiable weight clustering for large language model compression in accordance with one or more implementations. For explanatory purposes, the process 700 is primarily described herein with reference to the electronic device 110 of FIG. 1. However, the process 700 is not limited to the electronic device 110 of FIG. 1, and one or more blocks (or operations) of the process 700 may be performed by one or more other components of other suitable devices and/or servers. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, an apparatus (e.g., the electronic device 110, 112, 114, 116; ML model 220; processing unit(s) 812) determines an attention map between one or more learned weights of a trained machine learning model and corresponding centroids.

At block 704, the apparatus determines a compressed attention table and associated index list during compression of the trained machine learning model based on an uniquification of the attention map. In determining the compressed attention table, the apparatus can deconstruct the attention map into the compressed attention table with a memory complexity of O(|C|) and the associated index list with a memory complexity of O(|W|). In this example, W refers to a unique weight and C refers to a centroid. In one or more other implementations, the apparatus can shard the index list over |L| learners. In this regard, the memory complexity in each learner can be reduced to

$$O ( \frac{\vert W \vert}{\vert L \vert} )$$

based on the sharding.

At block 706, the apparatus determines a plurality of index lists based on a partitioning of the associated index list, as described with reference to FIG. 5. For example, the index list can be sharded over |Z| learners (e.g., L0, L1, L2, L3) into multiple index lists to reduce the complexity in each learner to

$$O ( \frac{\vert W \vert}{\vert L \vert} ) .$$

At block 708, the apparatus deploys a compressed machine learning model based at least in part on the compressed attention table and the plurality of index lists.

FIG. 8 illustrates an electronic system 800 with which one or more implementations of the subject technology may be implemented. The electronic system 800 can be, and/or can be a part of, the electronic device 110, and/or the server 120 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a flash drive, and its corresponding solid state drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input device interface 814 and output device interface 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the electronic device 110 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving a request to transfer a first tensor, that is a view of a second tensor from a first processor to a second processor;
determining whether a copy of the second tensor exists on the second processor;
when the copy of the second tensor does not exist on the second processor, copying the first tensor to the second processor; and
when the copy of the second tensor exists on the second processor, causing the second processor to generate another view of the copy of the second tensor at the second processor, the other view corresponding to the view, and forgoing the copying.

2. The method of claim 1, wherein copying the first tensor to the second processor comprises generating a reference associated with the first tensor, wherein the reference refers to a pointer indicating a memory location storing a copy of data in response to a memory write request.

3. The method of claim 1, wherein causing the second processor to generate the other view of the copy of the second tensor comprises causing the second processor to reuse a reference associated with the second tensor.

4. The method of claim 3, further comprising causing the second processor to reuse one or more data storage invariant operations between the first tensor and the second tensor.

5. A non-transitory machine-readable medium comprising code that, when executed by a processor, causes the processor to perform operations comprising:
initializing a trained machine learning model;
applying compression to the trained machine learning using cross-device tensor marshaling, wherein the cross-device tensor marshaling comprises:
determining whether a copy of a second tensor exists on a second processor, wherein the second tensor is a view of a first tensor requested to be transferred from a first processor to the second processor,
when the copy of the second tensor does not exist on the second processor, copying the first tensor to the second processor, and
when the copy of the second tensor exists on the second processor, causing the second processor to generate another view of the copy of the second tensor at the second processor, the other view corresponding to the view, and forgo the copying; and
deploying a compressed machine learning model based at least in part on the compression of the trained machine learning model.

6. The non-transitory machine-readable medium of claim 5, wherein copying the first tensor to the second processor comprises generating a reference associated with the first tensor, wherein the reference refers to a pointer indicating a memory location storing a copy of data in response to a memory write request.

7. The non-transitory machine-readable medium of claim 5, wherein causing the second processor to generate the other view of the copy of the second tensor comprises causing the second processor to reuse a reference associated with the second tensor.

8. The non-transitory machine-readable medium of claim 7, wherein the operations further comprise causing the second processor to reuse one or more data storage invariant operations between the first tensor and the second tensor.

9. The non-transitory machine-readable medium of claim 5, wherein applying the compression to the trained machine learning further comprises:
determining an attention map between one or more learned weights of the trained machine learning model and corresponding centroids; and
determining a compressed attention table and associated index list during compression of the trained machine learning model based on an uniquification of the attention map,
wherein the compressed machine learning model is further deployed based at least in part on the compressed attention table and associated index list.

10. The non-transitory machine-readable medium of claim 9, wherein applying the compression to the trained machine learning further comprises determining a plurality of index lists based on a partitioning of the associated index list, wherein the compressed machine learning model is further deployed based at least in part on the compressed attention table and the plurality of index lists.

11. The non-transitory machine-readable medium of claim 9, wherein determining the compressed attention table comprises deconstructing the attention map into the compressed attention table with a memory complexity of O(|C|) and the associated index list with a memory complexity of O(|W|), where W refers to a unique weight and C refers to a centroid.

12. The non-transitory machine-readable medium of claim 9, wherein the operations further comprise sharding the index list over |L| learners, wherein a memory complexity in each learner is reduced to
$$O ( \frac{\vert W \vert}{\vert L \vert} )$$
based on the sharding, where W refers to a unique weight and L refers to a learner.

13. A device, comprising:
a memory; and
one or more processors configured to:
initialize a trained machine learning model;
apply compression to the trained machine learning by:
determining an attention map between one or more learned weights of the trained machine learning model and corresponding centroids,
determining a compressed attention table and associated index list during compression of the trained machine learning model based on an uniquification of the attention map, and
determining a plurality of index lists based on a partitioning of the associated index list; and
deploy a compressed machine learning model based at least in part on the compressed attention table and associated index list.

14. The device of claim 13, wherein the one or more processors are further configured to apply the compression to the trained machine learning by determining a plurality of index lists based on a partitioning of the associated index list, wherein the compressed machine learning model is further deployed based at least in part on the compressed attention table and the plurality of index lists.

15. The device of claim 13, wherein the one or more processors are further configured to determine the compressed attention table by deconstructing the attention map into the compressed attention table with a memory complexity of O(|C|) and the associated index list with a memory complexity of O(|W|), where W refers to a unique weight and C refers to a centroid.

16. The device of claim 13, wherein the one or more processors are further configured to shard the associated index list over |L| learners, wherein a memory complexity in each learner is reduced to
$$O ( \frac{\vert W \vert}{\vert L \vert} )$$
based on the sharding, where W refers to a unique weight and L refers to a learner.

17. The device of claim 13, wherein the compression to the trained machine learning is applied further by using cross-device tensor marshaling, wherein the one or more processors are further configured to apply the cross-device tensor marshaling by:
determining whether a copy of a second tensor exists on a second processor, wherein the second tensor is a view of a first tensor requested to be transferred from a first processor to the second processor,
when the copy of the second tensor does not exist on the second processor, copying the first tensor to the second processor, and
when the copy of the second tensor exists on the second processor, causing the second processor to generate another view of the copy of the second tensor at the second processor, the other view corresponding to the view, and forgo the copying.

18. The device of claim 17, wherein copying the first tensor to the second processor comprises generating a reference associated with the first tensor, wherein the reference refers to a pointer indicating a memory location storing a copy of data in response to a memory write request.

19. The device of claim 17, wherein causing the second processor to generate the other view of the copy of the second tensor comprises causing the second processor to reuse a reference associated with the second tensor.

20. The device of claim 19, wherein the one or more processors are further configured to cause the second processor to reuse one or more data storage invariant operations between the first tensor and the second tensor.
